(19) United States
(12) Patent Application Publication
(10) Pub. No.: US 2007/0096588 A1
(43) Pub. Date: May 3, 2007

(54) ROTARY SUPPORT WITH ELASTIC CONNECTION DEVICE FOR INSTALLATION OF ELECTRIC MACHINES IN TUBES

(75) Inventor: KLAUS KIRCHNER, OSTHEIM (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, MUNCHEN (DE)

(21) Appl. No.: 10/596,729

(22) PCT Filed: Dec. 15, 2004
(86) PCT No.: PCT/EP04/53480

§ 371 Date: Jun. 22, 2006

(30) Foreign Application Priority Data
Dec. 23, 2003 (DE) 20319969.3

(51) Int. Cl. H02K 5/24; H02K 9/00; H02K 1/22

(52) U.S. Cl. 310/261; 310/58; 198/780; 310/51

(57) ABSTRACT

Torque transmission between a tube and a drive unit mounted in the tube is ensured with the aid of a component which is optimized for installation while providing a sufficient centering effect. A rotary support is hereby provided which is constructed as a hollow cylindrical body (1). An elastic connection device (3), e.g. an O ring which is disposed on the outer circumference of the hollow cylindrical member (1) in a defined arrangement, is used for elastically connecting the hollow cylindrical member (1) to the tube. The elastic connection device (3) has a centering and damping effect while ensuring the torque transmission, and channels (6) ensure a coolant flow passage/cooling circuit.

### BACKGROUND OF THE INVENTION

The present invention relates to a rotary support for mounting an electric machine in a tubular structure or a bore, having a hollow-cylindrical body which can be arranged in radial direction between the electric machine and the tubular structure or the bore, for torque transmission from the electric machine to the tubular structure or the bore.

Rolls with integrated drive are oftentimes used for conveyor belts. The motor or the motor with transmission, optionally together with control and brake, is hereby mounted in the roll. These components are to be secured axially and radially in the roll and have to transmit thereto at times high torques.

A problem relating to the securement of the drives in the rolls involve longitudinal joints or weld seams in the roll interior for maintaining integrity of the rolls. Thus, so called rotary support, in which the drives run, can be mounted through interference fit only in a very complicated manner. Longitudinal weld seams cause also centering problems during mounting of the rotary support in the tube.

Heretofore, worked-on rotary supports are centered i.a. by a press-fit with narrow tolerances. Prerequisite for centered press-fits are however either the provision of tubes without weld seams, i.e. drawn seamless tubes, or rotary supports with incorporated grooves or mechanically removed weld seams so that the presence of weld seams or overlappings do not influence the centering accuracy or result in damage during press-fitting.

In addition to the press-fits, centering and force transmission are also realized by glued connections with defined gap, or using a punch to swage local indentations. Moreover, connections by screws, pins, bolts or the like are known.

### SUMMARY OF THE INVENTION

The object of the present invention is thus based on optimizing the connection between a tubular structure or a bore and an electric machine installed therein and at the same time ensuring a high degree of centering precision and high torque transmission while simplifying installation.

This object is attained according to the invention by a rotary support for mounting an electric machine in a tubular structure or a bore, having a hollow-cylindrical body which can be arranged in radial direction between the electric machine and the tubular structure or the bore, for torque transmission from the electric machine to the tubular structure or the bore, and an elastic connection device which is arranged on the outer circumference of the hollow-cylindrical body for elastic connection of the hollow-cylindrical body with the tubular structure or the bore.

Preferably, the elastic connection device is detachably connectable to the tubular structure or the bore. In this way, it is possible to easily replace the motor for example from a roll of a conveyor device.

The elastic connection device may completely surround the circumference of the hollow-cylindrical body at one or more axial areas. As an alternative, components of the elastic connection device may be spaced at even distances in circumferential direction and/or axial direction on the outer surface area of the hollow-cylindrical body. The former variant ensures a force transmission from the entire circumference of the hollow-cylindrical body to a roll, while the latter variant enables a three-point support for example in the roll interior so that a coolant for example can flow past the components of the elastic connection device in longitudinal direction of the roll.

According to an especially advantageous embodiment, the elastic connection device has one or more components which are made of rubber or similar elastic material, or are coated therewith. The one or more components may hereby constitute formed parts of elastic, rubber-like material or solid rubber. In particular, the formed parts may be configured as O rings. The rubber-like components have the advantage of reduced manufacturing costs and easier installation. Moreover, such rubber components enable insertion of the rotary support deeper into the roll interior.

According to an embodiment which is also very much preferred, the elastic connection device has one or more components of metal, for example metal springs. The metal components may also be designed as tolerance rings of a shape and radial thickness that can be modified as a result of external pressure. These metal components have the advantage of allowing their use at higher temperatures and of exhibiting in general less wear.

Advantageously, the hollow-cylindrical body has fixing elements on its outer circumference for securing the elastic connection device. As a result, any formed components of the elastic connection device can be secured upon the outer circumference of the hollow-cylindrical body. Thus, there is no need for the components of the elastic connection device to rely on friction or internal stress to effect self-fixing in circumferential direction or axial direction.

When installed, the hollow-cylindrical body may moreover form with the tubular structure or the bore channels or passageways in longitudinal direction for circulation of the coolant and, optionally, for forming a closed cooling circuit. Despite centering and torque transmission, a good cooling effect is ensured of the electric motor in the roll interior for example.

It is also very advantageous to additionally conically shape the elastic connection device in relation to the length axis of the hollow-cylindrical body. In this way, it is easier to insert the rotary support in the roll. As a consequence of the rising squeezing force during insertion in longitudinal direction, the presence of a sufficient torque transmission is still ensured.

### BRIEF DESCRIPTION OF THE DRAWING

The invention will now be described in more detail with reference to the attached drawings in which:

FIG. 1 shows a perspective illustration of a first embodiment of a rotary support according to the invention;

FIG. 2 shows a cross sectional view of the rotary support of FIG. 1;

FIG. 3 shows a perspective illustration of the rotary support of FIG. 1 installed in a tube;

FIG. 4 shows a perspective illustration of a second embodiment of a rotary support according to the invention;

FIG. 5 shows a perspective illustration of a third embodiment of a rotary support according to the invention;

FIG. 6 shows a cross sectional view of the rotary support of FIG. 5 installed in a tube;

FIG. 7 shows a perspective illustration of the installed rotary support according to FIG. 6; and

FIG. 8 shows a cross sectional view of the rotary support of FIG. 3 for depiction of coolant circuits.

The exemplary embodiments as described in greater detail hereinafter represent preferred embodiment of the present invention.

### DETAILED DESCRIPTION OF PREFERRED EMBODIMENTS

The rotary support according to the invention essentially includes a tubular or hollow-cylindrical body 1 having a base part implemented as extruded profile or molded body. The hollow-cylindrical body 1 has an outer circumference provided with fixing elements 2 formed as elevations. The fixing elements 2 are evenly spaced about the circumference in three groups. Secured to the fixing elements 2 of one of the groups is an O ring 3 in such a manner as to project slightly radially beyond the fixing elements 2.

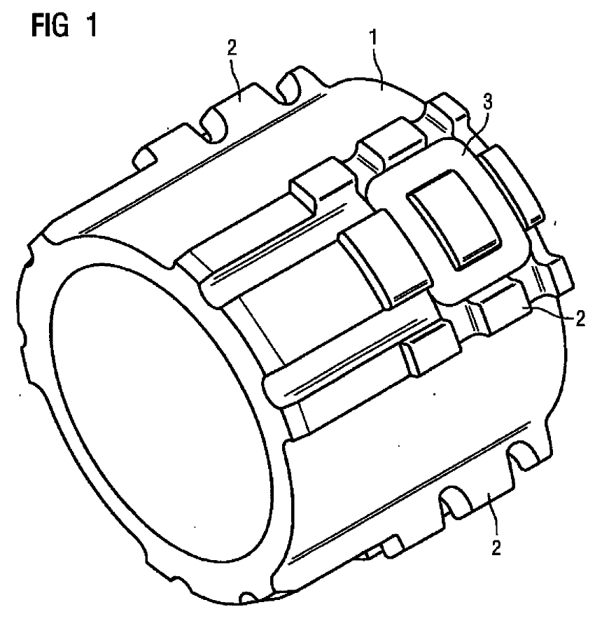

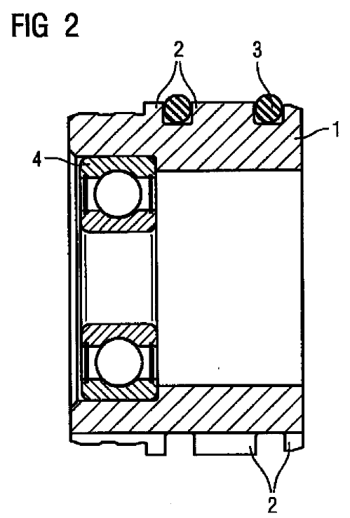

FIG. 2 shows a cross sectional view of the rotary support of FIG. 1 with inserted O ring 3. Press-fitted in the inner circumference of the hollow-cylindrical body 1 is a bearing 4.

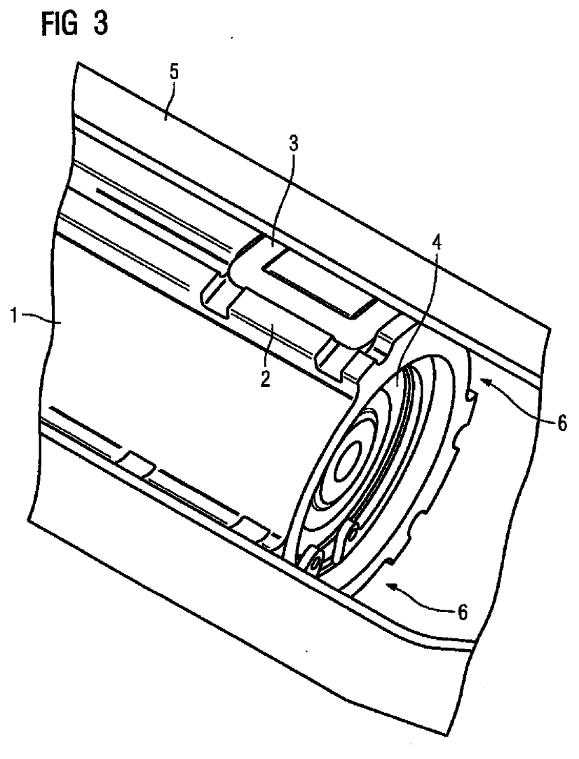

The rotary support can be pushed into a roll or tube 5, as illustrated in FIG. 3. As a result, it bears with three support surfaces as formed by three circumferentially spaced-apart O rings 3 upon the inner circumference of the tube 5. As the tube 5 is partly broken open in the illustration of FIG. 3, also the fixing elements 2, the hollow-cylindrical body 1, and the bearing 4 can be seen in addition to the O ring 3.

As a result of the design of the connection according to the invention between the rotary support and the tube, i.e. as a result of the small-area support surfaces formed by the O rings 3, seamlessly drawn tubes or also longitudinally welded tubes with weld seam or segmental tube and the like can be used for the rolls which are to be driven by the rotary support. The elasticity of the O rings 3 and the particular disposition of the fixing elements at the circumference compensate irregularities of the inner wall of the tubes and center the drive system.

Also shown in FIG. 3 are channels 6 which are formed between the inner tube wall and the hollow-cylindrical body 1 in length direction of the tube 5 as a result of the circumferential offset configuration of the fixing elements 2. They are provided for a circulation of a coolant or for dissipation of heat. Thus, a coolant can evenly flow about the hollow-cylindrical body 1 of the rotary support so that the drive or the brake in the rotary support can be cooled better.

Instead of the O ring 3, any formed part of rubber or similar elastic material can be used for attenuation, centering and torque transmission between rotary support and tube. The fixing elements 2 are then configured accordingly.

With respect to the length axis of rotation axis, it is beneficial to arrange the O rings 3 or other formed rubber parts slightly conically. This means that they or their base are slightly inclined in relation toward the end of the rotary support. As a consequence, it is easier to insert the rotary support in the tube 5. The contact pressure increases steadily during insertion.

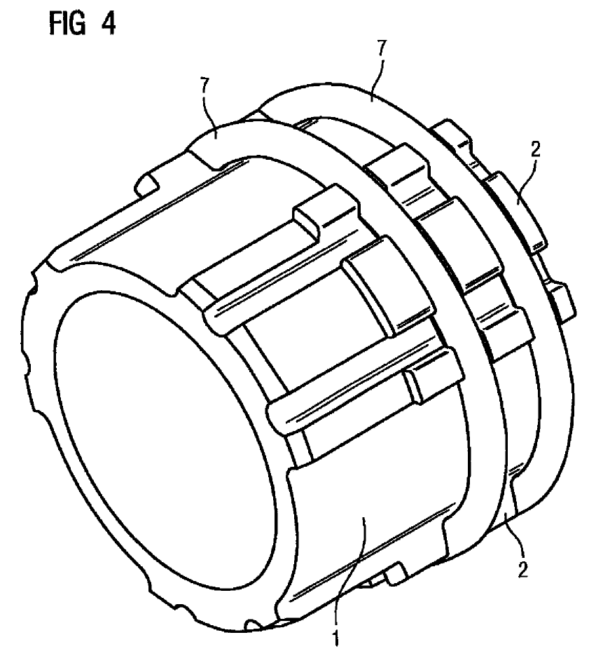

According to a second embodiment of the present invention, as shown in FIG. 4, two O rings 7 are used as elastic connection device in complete surrounding relationship to the circumference of the hollow-cylindrical body 1. A comparison with FIG. 1 shows that the fixing elements 2 have the same shape in both embodiments. Thus, a greater flexibility is established with respect to attachment of different O rings.

In the embodiment of FIG. 4, the O rings 7 extend also through the regions between the groups of fixing elements 2. This means that the coolant flow is slightly obstructed by the O rings 7, although not entirely suppressed. Thus, this embodiment can be used when cooling of the drive is less critical.

In both embodiments illustrated above in FIGS. 1 to 4, three support points or areas are respectively spaced upon the circumference. Of course, any other number of support points may also be selected. In addition, the supports may have any length in longitudinal direction. The diameter of the O rings may also be randomly selected. When choosing the size and material selection of the O rings, it is necessary to strike a balance between torque transmission, attenuation and centering.

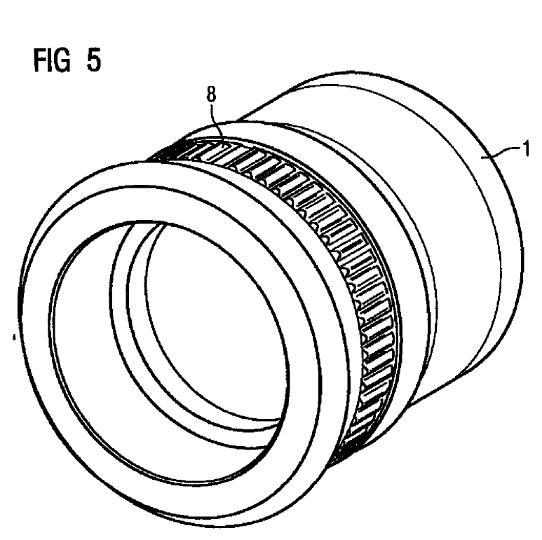

According to a third embodiment of the present invention, a tolerance ring made of metal is used as elastic connection device. Such a rotary support is shown in FIG. 5. The tolerance ring 8 is situated in a groove formed in the hollow-cylindrical body 1. The tolerance ring 8 is made of corrugated sheet metal so that its overall configuration but also its radial thickness can be modified. Such a tolerance ring also ensures a torque transmission, an axial securement as well as centering and attenuation of the rotary support in relation to the tube as a result of a force-fitting installation. These tolerance rings are standard components and available from Mannesmann-Star for example.

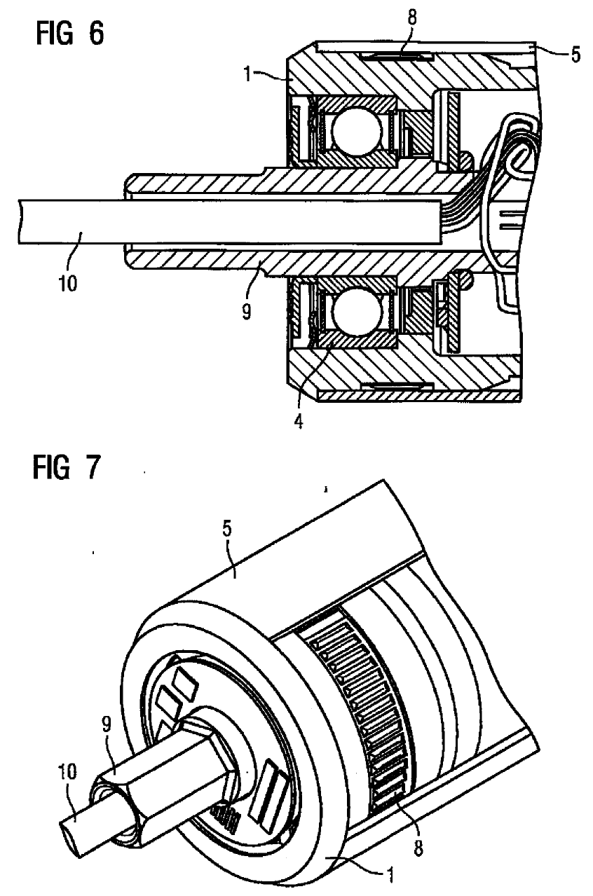

FIG. 6 shows a cross section through a rotary support, installed in a tube 5. The hollow-cylindrical body 1 is pushed into the tube 5. The tolerance ring 8 establishes the force-fitting connection between both these components. The rotary support is supported with the aid of a bearing 4 upon a hollows axle 9. Routed through the axle 9 is an electric connection cable 10 for supply of an unillustrated motor. FIG. 7 shows a perspective view of the installed rotary support with tolerance ring 8. The tolerance ring 8 is visible as the tube 5 in the selected illustration is partially broken open like in FIG. 3. The perspective illustration of FIG. 7 further shows the components designated in FIG. 6, except for the bearing 4.

A further advantage of this connection is the fact that the sensitive and press-critical installation components, e.g. electronic components, bearing and the like, are not clamped and damaged in view of the even, radially circumferential load during joining operation of round body (tube) and mounting part (e.g. motor unit).

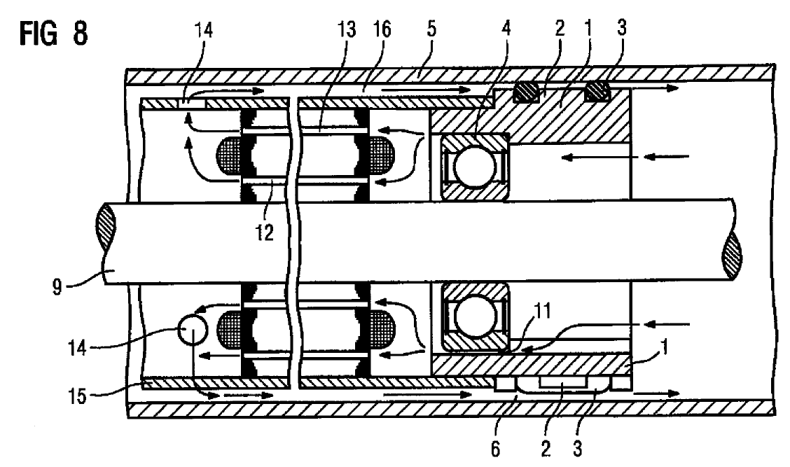

In all embodiment illustrated above, a motor mounted in the tube 5 can be cooled by a coolant flow circulating between or flowing past the elastic connection device 3, 7, 8. In some circumstances, it is advantageous, as shown in FIG. 8, to provide a coolant circuit in the tube 5. The coolant flow illustrated by arrows is guided through the rotary support or hollow-cylindrical body 1, through particular cooling channels 11 at the bearing 4, through the stator/rotor gap 12, and, optionally, parallel through motor cooling channels 12, radially outwards through openings 14 in the motor casing 15 at the other end of the motor, into a cylindrical gap or free space 16 between the motor casing 15 and the tube 5 for return in axial direction, and past the elastic connection device into the coolant channel 6 into the interior of the tube 5. As can be seen in the lower half of FIG. 8, the elastic connection device 3, here in the form of O rings, does not bear upon the entire inner circumference of tube 5 so that coolant passages in axial direction are ensured. The elastic connection device 3 can be seen in the coolant channel 6 in the background only.

As an alternative, cooling may also be established by a coolant flow in axial direction, i.e. without its reversal in axial direction. In this case, the coolant flows past the bearing through the motor and ultimately through the gap between tube and motor casing in same axial direction.

1. A rotary support for mounting an electric machine in a tubular structure or a bore, comprising:
a hollow-cylindrical body arranged in a radial direction between the electric machine and the tubular structure or the bore, for torque transmission from the electric machine to the tubular structure or the bore and
an elastic connection device arranged on an outer circumference of the hollow-cylindrical body for elastic connection of the hollow-cylindrical body with the tubular structure or the bore.

2. The rotary support of claim 1, wherein the elastic connection device is detachably connected to the tubular structure or the bore.

3. The rotary support of claim 1, wherein the elastic connection device completely surrounds the circumference of the hollow-cylindrical body at one or more axial areas.

4. The rotary support of claim 1, wherein the elastic connection device has components which are spaced at even distances in circumferential direction and/or axial direction on an outer surface area of the hollow-cylindrical body.

5. The rotary support of claim 1, wherein the elastic connection device has at least one component made of elastic material.

6. The rotary support of claim 5, wherein the component is a formed part of elastic, rubber-like material or solid rubber.

7. The rotary support of claim 6, wherein the formed part is an O ring.

8. The rotary support of claim 1, wherein the elastic connection device has ay least one component of metal.

9. The rotary support of claim 8, wherein the component is a tolerance ring of a shape and radial thickness that can be modified as a result of external pressure.

10. The rotary support of claim 1, wherein the hollow-cylindrical body has fixing elements on its outer circumference for securing the elastic connection device.

11. The rotary support of claim 1, wherein the hollow-cylindrical body forms, when installed, channels or passageways in longitudinal direction with the tubular structure or the bore for circulation of the coolant.

12. The rotary support of claim 1, wherein the elastic connection device has a conical shape.

13. A roll, comprising:
a motor; and
a rotary support according to claim 11, wherein the channels or passageways are part of a cooling circuit.

14. The rotary support of claim 5, wherein the elastic material is rubber.

15. The rotary support of claim 1, wherein the elastic connection device has at least one component provided with a coating of elastic material.

16. The rotary support of claim 1, wherein the elastic connection device has at least one component provided with a coating of rubber.

17. The rotary support of claim 1I, wherein the elastic connection device is arranged conically in relation to a length axis of the hollow-cylindrical body.
